(19) United States
(12) Patent Application Publication
(10) Pub. No.: US 2002/0174127 A1
(43) Pub. Date: Nov. 21, 2002

(54) Data organization system and method for classification structure management

(76) Inventors: Otto Preiss, Zeihen (CH); Thomas Werner, Baden (CH)

Correspondence Address: Robert S. Swecker, BURNS, DOANE, SWECKER & MATHIS, L.L.P., P.O. Box 1404, Alexandria, VA, 22313-1404, US

(21) Appl. No.: 10/084,916

(22) Filed: Mar. 1, 2002

(30) Foreign Application Priority Data
Mar. 7, 2001 (EP) 01810234.3

(51) Int. Cl. G06F 7/00

(52) U.S. Cl. 707/100

(57) ABSTRACT

The aim of the invention is a data organization system having at least one data classification structure for describing a classification system with user-definable classification elements which have a user-definable relationship with one another; one or more application programs which can use access means to access the data classification structure, and a program-internal data representation structure with classification elements which incorporate or are able to incorporate resources, where the data representation structure has been synchronized or can be synchronized with the data classification structure by its application program.

### DESCRIPTION

1. Technical Field

The present invention relates to a system and method for creating and maintaining a cross-program structure for organizing resources such as files, hyperlinks or the like in a data processing system.

2. Prior Art

Various data representation systems are used in data processing in order to make “user-unfriendly”organization systems with a technical basis more user-friendly owing to the fact that they are easier to read or are logical to the human user. Such a known system is represented by file systems on hard disks. In this case, user-definable file names are mapped onto structures on a hard disk which correspond to numerical addresses for data sectors on the hard disk. Within the context of management, the user is shown only the file and directory names in a hierarchical structure, and when these file and directory names are selected the numerically defined blocks are loaded from the hard disk in order to retrieve the respectively selected file.

On a higher level than a file system, many application programs permit the creation of a program-integrated, frequently hierarchical, structure in order to store resources which can respectively be processed by the application program, such as files, hyperlinks, e-mails, database entries etc., in logically structured form in a classification system desired by the respective user. This structuring permits faster and more efficient access to the resources. File systems are frequently still subject to the technical conditions of the operating systems and therefore do not allow sufficiently flexible configuration on the basis of the user's requirements. For many other resources, there are no system-wide structuring options at all, which means that incorporating an appropriate structure into the respective application program used is the only option for managing the appropriate resources. When creating an appropriate structure, the user specifies, by way of example, categories such as “work”, “project X”, “private addresses” or the like and allocates them resources which are intended to fall into the category. The application program creates respective references from the category elements to the resources. When the user calls a category, the resources associated with a category are displayed to the user.

When calling the respective resource, it is converted into machine-readable form again, usually at operating system level, and the data are supplied to the application program after they have been retrieved.

These known methods have various characteristic drawbacks, however. File systems are inherently limited to one type of resources, namely files. Structures in application programs permit only the management of resources of a type which can be processed by the application programs. In each application program, having an appropriate organization structure, the same steps need to be carried out, namely set up structure and maintain (modify, save, etc.) structure. Managing a large number of structures which have limited use is laborious and inefficient, particularly considering that the users often wish to use the same logical structuring in the various application programs.

The use of a logical information structure spanning application programs is therefore highly appropriate. Such an information structure does not exist to date. It is therefore an object of the present invention to provide the user with a system which permits consistent structuring of all resources.

This object is achieved by the data organization system in accordance with the independent patent claim 1 and also by the method for classification structure management in accordance with the independent patent claim 15. Other advantageous refinements, aspects and details can be found in the dependent patent claims and in the description.

### DESCRIPTION OF THE INVENTION

The invention is based on the principle of providing a standard data classification structure for various application programs which access the structure and can use it to set up a separate, program-internal structure for resource management. This makes it possible to attain a standard classification structure for resources between all programs which use the common data classification structure. The invention thus simplifies standard access to physically available resources in a data processing installation.

The aim of the invention is therefore a data organization system having

at least one data classification structure for describing a classification system with user-definable classification elements which have a user-definable relationship with one another; one or more application programs which can use access means to access the data classification structure, and a program-internal data representation structure with classification elements

which incorporate or are able to incorporate resources, where the data representation structure has been synchronized or can be synchronized with the data classification structure by its application program.

In this context, the cross-program or program-independent data classification structure more or less specifies a model containing classification elements, that is to say categories. The data classification structure is user-defined. Classification elements are details chosen by the user which the latter wishes to use to store resources in the individual application programs, i.e. he wishes to categorize these resources thereby.

On the basis of the invention, the classification elements have a relationship with one another. This relationship specifies the actual structuring of the classification elements and hence also the structuring of the actual resources in the individual application programs.

Each of the application programs incorporated into the system also has a program-internal data representation structure. This likewise comprises classification elements having a relationship with one another. Unlike the cross-program classification structure, however, in the data representation structure the user allocates resources to the classification elements. The data representation structure is thus used for actual resource management within a program. These data representation structures thus correspond to the structures already known from the prior art for managing resources, such as the URL directory in a WWW browser or an address register in an address management program.

In accordance with the invention, the application programs can use access means to access the external data classification structure. Within the context of the present invention, access means are understood to mean any devices or measures which are used for mediation between application programs and the data classification structure, i.e. permit access to and modification of the data classification structure from the application programs. These access means can be in the form of part of the application program and in the form of an external function.

It is important to the invention for the data classification structure and the data representation structures to be synchronized. Synchronization means that the classification elements of the data classification structure and the classification elements of the data representation structure, and their relationship with one another, are aligned either automatically or at the request of a user. After synchronization, the two structures thus have the same constitution in terms of the classification elements and the relationship between these classification elements.

Such synchronization can take place automatically, for example whenever an application program is started and when it is terminated, or else manually at the request of the user. Automatic synchronization makes it possible for all the application programs always to have the same structure in their data representation structures, which are also all identical to the data classification structure. Manual synchronization makes it possible for changes made by a user to the structure of a program to be available to other programs more or less directly.

One preferred embodiment also allows event-controlled synchronization to be carried out. For this, the application programs subscribe to an event handler which is informed about changes to the data classification structure and forwards these changes as events to the subscribed application programs, which can then carry out synchronization.

The event handler can be in the form of part of the access means or can be available as an independent unit or as a normal operating system service. The event handler can obtain the information relating to a change in the data classification structure from the access means making the changes, or from the application program implementing the changes after the latter has obtained acknowledgement of the change from the access means.

Automatic matching can also be achieved by virtue of the application programs incorporating a functionality which prompts automatic, time-controlled synchronization. In this way, it is possible to use the common data classification structure to transfer changes made to the structure of a program by a user to the respective data representation structures with a time delay even when programs are currently running, so that, despite changes, the user subsequently encounters the same resource structure in all programs.

It is also possible to provide a mechanism which the user can use to turn off synchronization of the common data classification structure and the respective application-program-specific data representation structure if, for example in a particular program, he needs an independent, separate structure which does not correspond to his normal, system-wide resource classification.

Even during program installation and afterward, the program user can continuously have the choice of whether he wishes to use the common data classification structure or the respective data representation structure which is specific to an application program.

Other variations for interchange of classification data between a data representation structure and the common classification structure can be envisaged on the basis of the invention, such as the option of copying application-specific structures into the data classification structure, so that the special aspects of said application-specific structures form part of the data classification structure.

On the basis of the invention, the data classification structure is accessed by access means. According to definition, these are any functionalities which are used for obtaining and transmitting information between application programs, or the data representation structures of the programs, and the common data classification structure. The access means can be incorporated into the application programs or can be in a form which is separate therefrom. In practice, combinations of these options will frequently arise, where part of the functionality is incorporated into the application programs and another part is in separate modules or programs. The text below will illustrate various options for implementing access to the data classification structure using the access means.

The invention can, by way of example, be characterized in that the access means have a functionality which is built into each of the application programs. This may involve a “stand-alone” solution in which all of the functionality required for access to the data classification structure is built into all the programs. This means that no other components are required which need to be incorporated into the system. However, this solution has the drawback that all of the functionality needs to be fully duplicated in each of the application programs using the system, which increases the programming complexity.

For this reason, frequently only some of the access means will be implemented in the application programs, while another portion is situated outside.

Thus, the access means can have, by way of example, an operating system component which can access the data classification structure and has a function interface, the functionality built into the application programs being function calls to the function interface.

Within the context of the present invention, an operating system component is to be understood as meaning any function grouping which is coupled to or managed by the operating system such that it is available to other programs which run on the operating system or communicate with the operating system via a network. For communication with other programs, the operating system component has a function interface which can be used to call the functions implemented in the operating system component and which can be used to return results of the functions to calling programs. The function calls are inquiries to the operating system component which are sent to the operating system component via the function interface in a prescribed format and in the form of particular inquiry types. Transmission usually takes place using the normal methods provided for interprocess communication in the operating system.

To produce the operating system component, various options are available. These range from hardware components which can undertake direct implementation, for example in the case of relatively small data processing appliances such as radio telephones or more specific appliances, up to database systems.

In one preferred embodiment of the present invention, the operating system component is a dynamic link library with an “application programming interface” (API), the function calls then being calls to the “application programming interface”. The person skilled in the art is familiar with the implementation of dynamic link libraries in different variations and the use thereof in various operating systems. They are a standard approach for allowing functions to be made available to various programs. After a dynamic link library has been produced, the calls to the API can be incorporated into the source text of programs, and the compiling can be done such that the executable program can interact with the dynamic link library during program execution. In this context, the function calls for addressing particular functions of the link library can be resolved either during compiling (early binding) or else only at the time of execution of the respective software (late binding). Which of the methods is chosen depends on the conditions to be satisfied and on the programming language used.

Within the context of the present invention, the term dynamic link library is also intended to be understood to mean other types of extensions which do not add to the functionality of a program until at the time of its execution, in particular on operating systems, and/or using programming languages, which do not have the dynamic link library concept.

In an alternative approach, the operating system component can be a program, and the function calls can be program calls with parameter transfers. In many operating system environments, functions are available which can be used by one program to call another in order to use the functions of the latter. In this case, the programs communicate using standard procedures, for example “pipes” or “streams”, as is familiar to the person skilled in the art. When using a special program which can manage and interrogate the data classification structure, the inquiring application program concurrently transfers parameters which the program converts into instructions for calling special functions.

In this context, the program can be a database system, with the data classification structure being managed by the database system. In this case, the data classification structure is in the form of a database, i.e. in the form of a file or file group in a special format used by the database system.

The data classification structure in the present invention will be explained below. As already stated above, the data classification structure comprises at least classification elements and relationships between the classification elements.

The classification elements are terms defined by the user which he wishes to use to subdivide the resources he uses, in order to allocate them particular subject complexes which are logical to him. The classification elements need to be able to reproduce the user's ideas with as few technical limitations as possible. To this end, it is appropriate upon definition to provide as complete as possible a character set, including special characters and numbers which the user can use to name the classification elements. It is similarly conceivable to provide image elements or to provide the user with the option of designing image elements himself and/or of incorporating them into the data classification structure.

The user is unrestricted in the choice of classification elements. Thus, he can name classification elements on the basis of particular projects, can subdivide them into private or business, can assign months, etc.

Apart from the naming of classification elements (using character strings and/or image elements, see above), definition of the data classification structure by the user also covers the relationship between classification elements. On the basis of the invention, the relationship between the classification elements can comprise their sequence and their hierarchical arrangement. In this context, the sequence determines how the classification elements are presented to the user when he looks at them. The sequence can likewise be defined freely by the user. However, it is also possible for the sequence to be defined automatically, for example by the access means. By way of example, an automatic sequence can be produced alphabetically or by simply appending new classification elements to the data classification structure.

Another option, which is preferable in accordance with the invention, is the relationship between the classification elements in a hierarchical arrangement. It is often appropriate to subdivide categories of resources further, for example projects into subprojects or information categories into subsidiary information categories. For this reason, the invention preferably provides for classification elements to be able, in turn, to have classification elements arranged below them which are on a hierarchically lower level. When displaying the data classification structure or the application programs' data representation structures derived therefrom, this can, by way of example, influence the display of the structures on the screen, for example by virtue of subordinate classification elements being displayed only after the user has selected (e.g. using the cursor or a mouse) the superordinate classification element under which they are classified, or by virtue of subordinate classification elements being indented below the superordinate classification element.

Besides the classification elements and information about their relationship with one another, the data classification structure can contain other information. Thus, it can likewise contain information about an owner (user), such as a version number if a plurality of versions are to be operated in parallel, or information about specific resources which need to be available in all the application programs, for example.

It is also possible to provide the classification elements and/or the data classification structure with attributes which can contain other information. Thus, by way of example, attributes can be used to identify particular classification elements (including or excluding classification elements which are subordinate thereto) as read-only, i.e. unmodifiable. By associating classification elements with particular users, it is possible to identify particular classification elements in data classification structures which are used by entire workgroups as being modifiable only by the owners.

Attributes can also be user details which, if appropriate, can be linked to particular additional or restricted rights for particular users or user groups.

Attributes can also be used to determine the relationship between the elements. In this context, by way of example, attribute values can stipulate the order of the classification elements when they are displayed in application programs. In this way, it is not necessary to change over the whole data classification structure in the event of changes, but rather it suffices to change the attribute values.

The attributes can also act hierarchically downward by virtue of an attribute which applies to a superordinate classification element automatically also being used for classification elements which are subordinate thereto (inheritance of the attribute values). Such attributes can be overwritten on lower levels (overriding).

As mentioned above, the data classification structure can be held in a database. For reasons of simpler implementation and maintainability, however, it will frequently be preferable for the data classification structure to be a file which contains a structured list containing entries showing the classification elements and their relationship with one another, where the relationships are shown by an arrangement of the classification elements within the file.

In simple cases, the sequence of the classification elements can simply be stipulated by the sequence of the classification elements in this file, while the hierarchical arrangement can be produced by indenting subordinate classification elements below the superordinate one. In other embodiments, the classification elements can be provided with index tags (attributes), the relationship being able to be produced by a list containing index tags which can respectively use their references to one another to determine the relationship between the classification elements.

In particular, it is preferred for the file used to produce the data classification structure to be an XML file. XML (extended Markup Language) is a page description language for displaying and storing information, where the individual items of information are associated with “tags” which allow structuring. The targeted use of tags means that XML allows, in particular, categorization of information and targeted access to this information using the tags.

The various application programs incorporated into the inventive data organization system have separate data representation structures for managing the actual resources which can be used by the respective program. The constitution of these structures therefore differs from that of the inventive data classification structure in that they contain additional resource information. The resources which can be used by the application programs can differ considerably from program to program. It is preferred for the resources in the data representation structure to be able to be objects in file systems, objects in files, data records in databases and objects in computer networks, without this listing having to be complete. This covers the broadest possible spectrum of various resources. Objects in file systems can, by way of example, be files or directories present on hard disks or in network file systems; objects in files can be, by way of example, entries in an address book; data records in databases can be collections of interlinked information stored in a particular database; and objects in computer networks can be, by way of example, URLs (Universal Resource Locator) in the World Wide Web or entries in other Internet services, such as WAYS or ftp.

Up to now, essentially the organization of the classification elements and resources and of the link between the various elements of the invention has been described. The text below will explain what requirements the access means may have. First, the access means preferably have a functionality which is incorporated into the respective application program and which converts user inputs into instructions for manipulating the inventive data classification structure, for example relating to changes or relating to synchronization. These instructions can either be used within a program or are forwarded to other access means, which perform the actual access to the data classification structure.

To be able to perform this task, the access means preferably have:

means for receiving instructions from application programs which relate to the interrogation and/or manipulation of the data classification structure;

means for reading and/or manipulating the classification elements contained in the data classification structure and their relationship using the instructions received; and

means for transferring data classification structure data which have been read to the interrogating application program.

Apart from during synchronization, it may from time to time be desirable to make changes to the common data classification structure in order, by way of example, to produce a new organization concept for the separate activity. Instead of doing this in a data representation structure by way of example, it may be desirable to change the common structure directly. The inventive data organization system can therefore be characterized in that at least one of the application programs has functions for creating and manipulating the classification elements of the data classification structure and their relationships with one another. In this way, any changes can be made directly and not via the indirect route of the data representation structure. Not all of the application programs need to have this intervention option, but rather just one program is sufficient. Alternatively, it is also possible to provide for this purpose a special program which has functions for managing the data classification structure. This program can access the data classification structure either using separate mechanisms or using the normal access means.

The inventive data organization system can preferably be a computer program product whose constituents are at least in part able to be loaded directly into the main memory of a digital data processing installation and whose program constituents can be executed by the data processing installation.

The invention is also aimed at a method. This method effects the inventive synchronization between a data representation structure and the common data classification structure. Everything which has been said with regard to the data organization system applies to the method likewise, so that reference is made to the entire content thereof.

The inventive method for classification structure management has the following steps:

an application program reads a data classification structure for describing a classification system with user-definable classification elements which have a user-definable relationship with one another;

a program-internal data representation structure with classification elements incorporating or able to incorporate resources is read; differences are established between the data classification structure and the program-internal data representation structure; and

the data classification structure and the program-internal data representation structure are synchronized in terms of their respective classification elements and their relationship with one another.

As already explained above, synchronization causes alignment of the classification elements and their relationship with one another, the data classification structure and the data representation structure.

In this context, the synchronization can be alignment of the program-internal data representation structure with the data classification structure, or alternatively alignment of the data classification structure with the program-internal data representation structure. The type of synchronization can either be firmly prescribed or a decision can be made regarding which structure is aligned. The decision regarding which structure is aligned with which during synchronization can be made either as defined by the user or can be made automatically by a functionality built into the program or into the access means. In this context, it is possible to use criteria such as the time of the last change (the old structure is aligned with the more recent one) or the number of changes since a prescribed time (the structure with the most changes is retained, and the other is aligned). Any attributes there are can also be evaluated here, in order, by way of example, to prevent read-only classification elements from being changed. In this context, the concept of changing can relate both to the name of a classification element and to the relationship between the element and other elements. The inventive method can also be characterized in that, before the data classification structure is read for the first time, the following step is performed by one of the application programs or a specific application program:

the user-definable data classification structure is created.

This preparatory step actually allows the data classification structure to be produced for the first time. This can be done by using an existing data representation structure as the basis for producing the data classification structure, or by virtue of an application program directly providing the user with the option of creating the data classification structure. It is appropriate for these programs to be the same ones as have already been described above with reference to management of the data classification structure.

The appearance of an inventive data classification structure will be explained in more detail below using an example. The example is based on the page description language XML, a preferred embodiment.

```
<System AccessRights=“R” LastModified=“21.02.2001”>
  <Projects>
    <Y2000/>
    <Y2001>
      <CRID10070 AccessRights=“RW” SortBy=“Last
Modified” User=“Meyer=R” Node=“Synchronize”>
        <Mails/>
        <Planning/>
        <Org/>
        <Financial/>
        <Progress/>
        <Results/>
        <Software/>
        <Documentation/>
      </CRID10070>
<CRID1768/>
    </Y2001>
  </Projects>
  <Private Node=“Modify”>
    <Computer/>
    <Microsoft/>
    <NET/>
    <Programming/>
    <Auto/>
    <Apartment/>
    <Accounts>
      <DB24/>
      <Consors/>
      <Postbank/>
    </Accounts>
    <Shares>
      <Research/>
      <Deposits/>
    </Shares>
    <Sport>
      <Mountain biking/>
      <Walking/>
      <Paragliding/>
    </Sport>
  </Private>
  <Misc/>
  <ABB>
    <Structure/>
    <Contacts/>
    <Info/>
  </ABB>
  <Interesting/>
  <Links/>
  <Favorites/>
</System>
```

As can be seen, the example above contains a series of classification elements which, typically for XML, are each enclosed in angle brackets. The various hierarchical levels are logically separated by the various tag forms. Classification elements which in turn contain subordinate elements are bounded by the two tags “<classification element>” and “</classification element>”, while classification elements on the lowest hierarchical level, which have no further subordinate classification elements, comprise a single entry in the form “<classification element/>”. The highest level of the classification structure is enclosed by <system> . . . </system>. In the present example, this level has the hierarchically subordinate entries <Projects>, <Private>, <Misc/>, <ABB>, <Interesting/>, <Links/> and <Favorites/>. These are completely different terms which have nevertheless been combined into a standard data classification structure reflecting the personal ideas of a user.

The example likewise explains the use of attributes. These can be hierarchically shared attributes, i.e. an attribute from the “System” level, for example, is also visible at all lower nodes. Attributes can be overwritten.

The “AccessRights” attribute is used to stipulate read and write authorizations; in the present case using the three values R (Read), W (Write) and RW (Read and Write). It is likewise possible to indicate the date of the last modification, which is indicated by the attribute “LastModified”, the date format also possibly being different than in the present example. This attribute can be used for sorting purposes, for example.

In the specific exemplary embodiment, the “SortBy” attribute allows explicit indication of a sorting order for a node (in this case on the basis of the “LastModified” attribute, for example).

The “Node” attribute with the values “Modify” and “Synchronize” stipulates synchronization, for example. With the “Synchronize” value, a program has the master rights to this node, and automatic synchronization is always carried out. The “Modify” value stipulates that the node can have various branches in application programs.

The “User” attribute allows rights to be additionally granted or restricted for particular users or user groups.

The use of XML in the present example has the advantage that known processors for XML can be used to process the data classification structure file, which means that it is likewise possible to use known APIs when matching the application programs.

Advantages of the inventive data classification structure can be seen in that the user need produce it only once and it can be stored and maintained at a central location, with all the changes made then affecting all the applications which use the structure. If the data classification structure is designed to be portable, this has the enormous advantage, even in the case of possible new installations of the operating system, that the structure need no longer be input manually, but rather can be transferred simply by copying.

1. A data organization system having
at least one data classification structure for describing a classification system with user-definable classification elements which have a user-definable relationship with one another;
one or more application programs which can use access means to access the data classification structure and which have a program-internal data representation structure with classification elements, said classification elements incorporating or being able to incorporate resources;
where the data representation structure of an application program has been synchronized with the data classification structure or can be synchronized with the data classification structure by the application program.

2. The data organization system as claimed in claim 1, characterized in that the access means have a functionality which is built into each of the application programs.

3. The data organization system as claimed in claim 2, characterized in that the access means have an operating system component which can access the data classification structure and has a function interface, and the functionality built into the application programs is function calls to the function interface.

4. The data organization system as claimed in claim 3, characterized in that the operating system component is a dynamic link library with an “application programming interface”, and the function calls are calls to the “application programming interface”.

5. The data organization system as claimed in claim 3, characterized in that the operating system component is a program, and the function calls are program calls with parameter transfers.

6. The data organization system as claimed in claim 5, characterized in that the program is a database system, and the data classification structure is managed by the database system.

7. The data organization system as claimed in one of claims 1 to 6, characterized in that the relationship between the classification elements comprises their sequence and their hierarchical arrangement.

8. The data organization system as claimed in one of claims 1 to 7, characterized in that the data classification structure is a file which contains a structured list containing entries showing the classification elements and their relationship with one another, where the relationship is shown by an arrangement of the classification elements within the file.

9. The data organization system as claimed in claim 8, characterized in that the file is an XML file.

10. The data organization system as claimed in one of claims 1 to 9, characterized in that the resources in the data representation structure can be objects in file systems, objects in files, data records in databases and objects in computer networks.

11. The data organization system as claimed in one of claims 1 to 10, characterized in that the access means have
means for receiving instructions from application programs which relate to the interrogation and/or manipulation of the data classification structure;
means for reading and/or manipulating the classification elements contained in the data classification structure and their relationship using the instructions received; and
means for transferring data classification structure data which have been read to the interrogating application program.

12. The data organization system as claimed in one of claims 1 to 11, characterized in that at least one of the application programs has functions for creating and manipulating the classification elements of the data classification structure and their relationships with one another.

13. The data organization system as claimed in one of claims 1 to 12, characterized in that a special program has functions for managing the data classification structure.

14. The data organization system as claimed in one of claims 1 to 13, characterized in that it is a computer program product whose constituents are at least in part able to be loaded directly into the main memory of a digital data processing installation and whose program constituents can be executed by the data processing installation.

15. A method for classification structure management having the following steps:
an application program reads a data classification structure for describing a classification system with user-definable classification elements which have a user-definable relationship with one another;
a program-internal data representation structure with classification elements incorporating or able to incorporate resources is read;
differences are established between the data classification structure and the program-internal data representation structure; and
the data classification structure and the program-internal data representation structure are synchronized in terms of their respective classification elements and their relationship with one another.

16. The method as claimed in claim 15, characterized in that the synchronization is alignment of the program-internal data representation structure with the data classification structure.

17. The method as claimed in claim 15, characterized in that the synchronization is alignment of the data classification structure with the program-internal data representation structure.

18. The method as claimed in one of claims 15 to 17, characterized in that, before the data classification structure is read for the first time, the following step is performed by one of the application programs or a specific application program:
the user-definable data classification structure is created.
